(19) United States
(12) Patent Application Publication
(10) Pub. No.: US 2019/0347037 A1
(43) Pub. Date: Nov. 14, 2019

(54) DATA STORAGE APPARATUS AND SYSTEM INFORMATION PROGRAMMING METHOD THEREFOR

(71) Applicant: Silicon Motion, Inc., Zhubei City (TW)

(72) Inventors: Ching-Ke CHEN, Zhubei City (TW); Po-Sheng CHOU, Zhubei City (TW); Yang-Chih SHEN, Taoyuan City (TW)

(73) Assignee: Silicon Motion, Inc., Zhubei City (TW)

(21) Appl. No.: 16/410,163

(22) Filed: May 13, 2019

(30) Foreign Application Priority Data
May 14, 2018 (TW) 107116350
Jun. 5, 2018 (TW) 107119381

(51) Int. Cl. G06F 3/06

(52) U.S. Cl. CPC G06F 3/0658; G06F 3/0673; G06F 3/0644; G06F 3/064

(57) ABSTRACT

The disclosure discloses a data storage apparatus and a system information programming method. The data storage apparatus includes a non-volatile memory and a memory controller. The non-volatile memory includes a logical unit number (LUN). The LUN includes a number of planes. Each plane includes a number of blocks. Each block includes a number of pages. The memory controller is configured to select a number of member blocks from a number of blocks on each plane of the LUN to form a big block, divide the big block into a number of small blocks according to a plane amount parameter, group the pages on different planes of each small block to form a number of big pages according to a page or plane orientation, and write a system information to at least one of the big pages.

This application claims the benefit of Taiwan application Serial No. 107116350, filed May 14, 2018 and Taiwan application Serial No. 107119381, filed Jun. 5, 2018 the subject matters of which are incorporated herein by reference.

### BACKGROUND OF THE DISCLOSURE

### Field of the Disclosure

The disclosure relates in general to a data storage apparatus and a system information programming method.

### Description of the Related Art

Along with the advance in the manufacturing technology of memory, the unit storage capacity of the memory is getting larger and larger. In recent years, the internal structure of the memory is directed towards the trend of increasing the storage capacity of each block but decreasing the total amount of blocks. In other words, the memory is directed towards the trend of “less blocks but larger block capacity”. According to the method used in most of the existing technologies, the internal information of the memory is decentralized and stored to different blocks or super blocks. As the storage capacity of the block is getting larger and larger, this method will waste too much available space.

### SUMMARY OF THE DISCLOSURE

The disclosure is directed to a data storage apparatus and a system information programming method thereof.

According to one embodiment of the disclosure, a data storage apparatus includes a non-volatile memory and the memory controller. The non-volatile memory includes a logical unit number (LUN). The LUN includes a number of planes. Each plane includes a number of blocks. Each block includes a number of pages. The memory controller is coupled to the non-volatile memory and configured to select a number of member blocks from a number of blocks on each plane of the LUN to form a big block, divide the big block into a number of small blocks according to a plane amount parameter, group the pages on different planes of each small block to form a number of big pages according to a page or plane orientation, and write a system information to at least one of the big pages.

According to another embodiment of the disclosure, a data storage apparatus including a non-volatile memory and a memory controller is disclosed. The non-volatile memory includes a number of logical unit numbers (LUNs). Each LUN includes a number of planes. Each plane includes a number of blocks. Each block includes a number of pages. The memory controller is coupled to the non-volatile memory and configured to select a number of member blocks from a number of blocks on each plane of the LUNs to form a super block, divide the super block into a number of small blocks according to a plane amount parameter, group the pages on different planes of each small block to form a number of big pages according to a page or plane orientation, and write a system information to at least one of the big pages.

According to an alternate embodiment of the disclosure, a system information programming method for a data storage apparatus is disclosed. The programming method includes respectively selecting a member block from a number of blocks on each plane of a LUN of the non-volatile memory to form a big block, divide the big block into a number of small blocks according to a plane amount parameter, group the pages on different planes of each small block to form a number of big pages according to a page or plane orientation, and write a system information to at least one of the big pages.

According to another alternate embodiment of the disclosure, a system information programming method for a data storage apparatus, the programming method includes respectively selecting a member block from a number of blocks on each plane of a number of LUNs of the non-volatile memory to form a super block, divide the super block into a number of small blocks according to a plane amount parameter, group the pages on different planes of each small block to form a number of big pages according to a page or plane orientation, and write a system information to at least one of the big pages.

The data storage apparatus and the system information programming method of the disclosure effectively use the data storage space of the data storage apparatus. Furthermore, when recording the system information, the data storage apparatus and the system information programming method simultaneously record the system information code and the recording table to accelerate the data restoring procedure.

The above and other aspects of the disclosure will become better understood with regards to the following detailed description of the preferred but non-limiting embodiment (s). The following description is made with reference to the accompanying drawings.

### BRIEF DESCRIPTION OF THE DRAWINGS

FIG. 1 is a block diagram of a data storage apparatus according to an embodiment of the disclosure.

FIG. 2A is a flowchart of a system information programming method according to an embodiment of the disclosure.

FIG. 2B is a schematic diagram of the composition of a big block and big pages according to an embodiment of the disclosure.

FIG. 2C is a schematic diagram of a big block composed of big pages according to an embodiment of the disclosure.

FIG. 2D is a schematic diagram of the composition of a big block and big pages according to another embodiment of the disclosure.

FIG. 3A is an embodiment of step S208.

FIG. 3B is another embodiment of step S208.

FIG. 4A is a block diagram of a data storage apparatus according to another embodiment of the disclosure.

FIG. 4B is a flowchart of a system information programming method according to another embodiment of the disclosure.

### DETAILED DESCRIPTION OF THE DISCLOSURE

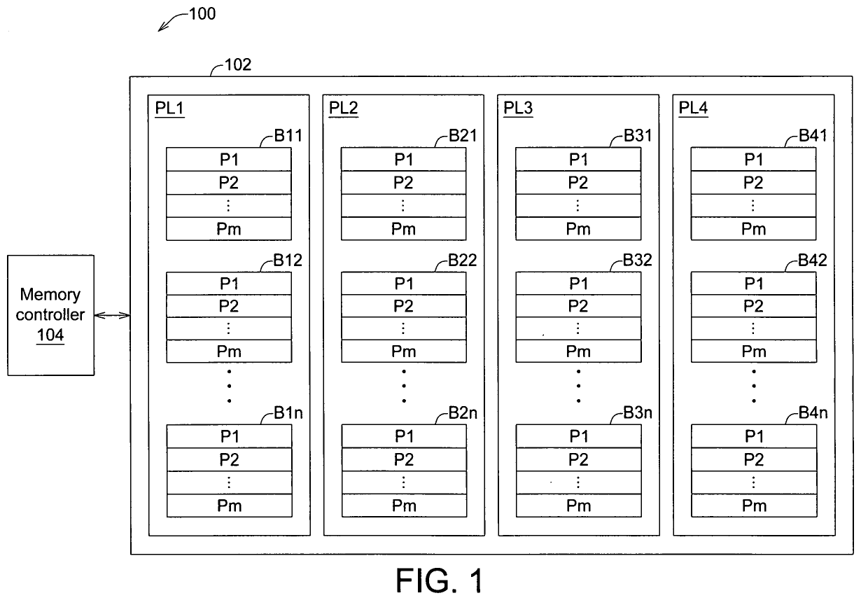

Referring to FIG. 1, a block diagram of a data storage apparatus according to an embodiment of the disclosure is shown. The data storage apparatus 100 mainly includes a non-volatile memory 102 and a memory controller 104, and may further include a volatile memory to temporarily store the user data or the firmware or the logical to physical (L2P) mapping table required for the operation of the memory controller 104. The memory controller 104 is coupled to the non-volatile memory 102, and can perform the system information programming method disclosed in the embodiments of the disclosure.

The non-volatile memory 102 can be a NAND flash memory. The memory controller 104 can be implemented as one or more than one control chip capable of transceiving data and instructions to or from the non-volatile memory 102 to perform operation to non-volatile memory 102, for example, to read, program, or erase the non-volatile memory 102.

The non-volatile memory 102 preferably has one or more than one logical unit number (LUN), which can be selected/enabled by a chip enable (CE) signal. Each logical unit number (LUN) includes, for example, four planes, namely, planes PL1˜PL4. Each of the planes PL1˜PL4 includes, for example, 2048 blocks, namely, blocks Bk1˜Bkn, wherein k=1, 2, 3, 4, n=2048. Each of the blocks Bk1˜Bkn includes, for example, 1024 pages, namely, pages P1˜Pm, wherein m=1024. Each page can be controlled by a word line, and each word line can control more than one page. A page includes, for example, 16768B data storage space, and can be divided into a 16 KB data area and 384B spare areas. The data area can store data (user data or system information). The spare area can store the metadata of data. Each word line includes, for example, 16 KB memory cells (not shown). Besides, the memory cells on the word line can be quad level cells (QLC), triple level cells (TLC), multiple level cells (MLC) or single level cells (SLC). It should be noted that the present embodiment is for exemplary purpose only, and the amount of chips, planes, blocks, pages, word lines and memory cells can be designed and arranged according to actual needs.

The data storage apparatus 100 can further be coupled to a host (not shown). The host can output a data access instruction (for example, an instruction to read or write data) to the data storage apparatus 100 to access (read or write) user data of the data storage apparatus 100. For example, in response to the data access instruction outputted from the host, the memory controller 104 of the data storage apparatus 100 can read data from one or more than one physical address in the non-volatile memory 102. The host can be, for example, a personal computer, a mobile phone, a PC tablet, an on-board unit, or a navigation device.

The system information of the data storage apparatus 100 can be, for example, system specification, operating parameter, bad block information, block linking table, block attribute table (recording, for example, the erase count or the amount of valid pages), debugging information table (for example, SMART information table) and/or logical to physical (L2P) mapping table. The mapping information table, also referred as advanced mapping information, records the address information of each sub-L2P mapping table of the L2P mapping table. Unlike the user data, the default (or maximum) size of the system information may not be identical. For example, the block linking table has a size of 380 KB, the mapping information table has a size of 90 KB, and the bad block information has a size of 4 KB. In the system information mentioned above, the block linking table records the order in which the blocks are used, and the block linking table is normally updated when the end of block (EOB) information is written to any block. In order to improve the data storage ability, the memory controller 104 preferably performs the system information programming in the non-predetermined mode or SLC mode. When the system information programming is performing in the SLC mode, a word line can control only one page. Also, along with the operation of the data storage apparatus 100, the memory controller 104 continuously updates the system information.

Logically, the L2P mapping table can be composed of a number of sub-L2P mapping tables, for example, 2048 sub-L2P mapping tables. Each sub-L2P mapping table preferably includes the mapping information of the physical address of a number of continuous logic addresses, for example, the mapping information of the physical address of 32K continuous logic addresses. When a sub-L2P mapping table is updated, the memory controller 104 stores the updated sub-L2P mapping table and records the updated storage address to the mapping information table.

For the efficiency of the data storage apparatus 100 to be maximized, during data (user data or system information) writing, the memory controller 104 normally writes data to the non-volatile memory 102 by performing an inter-leaving programming process since each LUN includes four planes. For example, data are simultaneously written to the blocks (pages of blocks) of all planes. For example, the data are simultaneously written to the block B11 on the plane PL1, the block B21 on the plane PL2, the block B31 on the plane PL3, and the block B41 on the plane PL4 to achieve a higher data write speed.

It is true that writing user data to the blocks of all planes by performing an inter-leaving programming process can achieve the expected effect. However, writing user data to the blocks of all planes by performing an inter-leaving programming process may cause waste in storage space. In the above example, with a conventional inter-leaving programming process, 4 pages of 4 blocks on 4 planes can store 64 KB (4 times of 16 KB) of data, but the system information only has 30 KB. Therefore, to perform the inter-leaving programming process, the memory controller 104 will form 34 KB of dummy data, and group 34 KB of dummy data and 30 KB of system information to form 64 KB of data, and further write the 64 KB data (including system information) to the blocks of all planes by performing an inter-leaving programming process. Therefore, each time when an item of system information is updated/written, the non-volatile memory 102 will store 34 KB of dummy data. With the increasing of the update count of the system information, the non-volatile memory 102 will store a large amount of dummy data, and a large amount of storage space of the non-volatile memory 102 will be occupied. Thus, the memory controller 104 performs the write operation of the system information by using the operating method described below.

It should be noted that in order to simplify the descriptions, only components relevant to the disclosure are shown in FIG. 1. It should be understood that the implementation of the disclosure is not limited to the block diagram shown in FIG. 1.

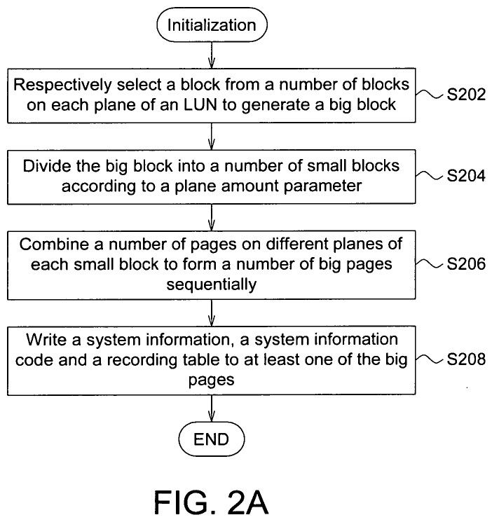

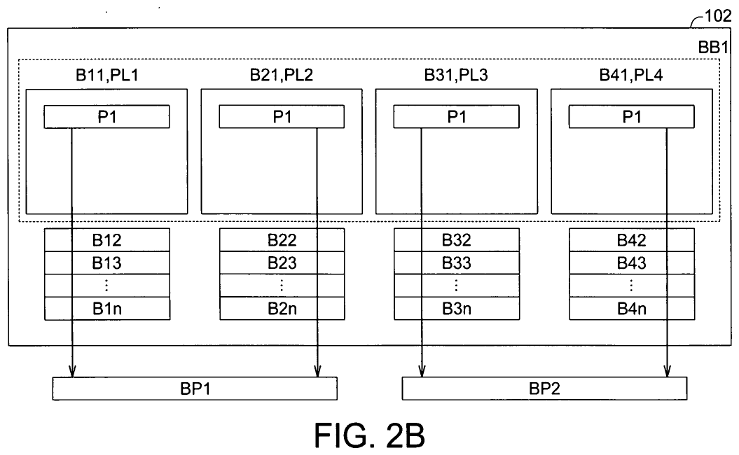

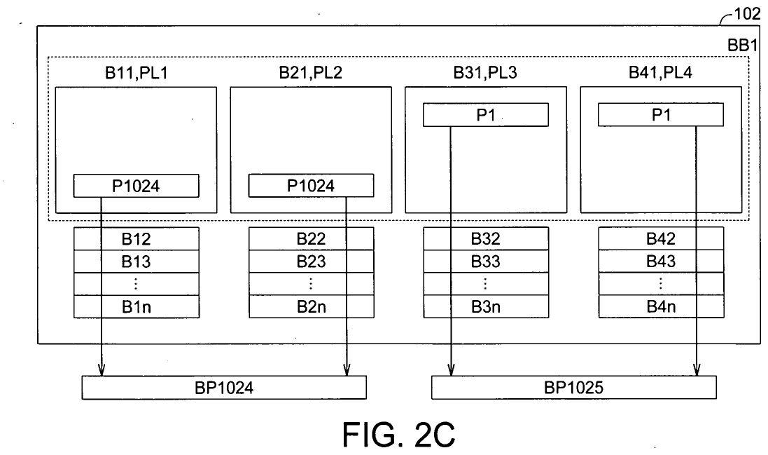

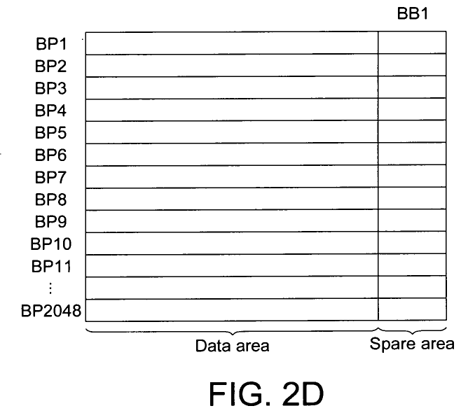

Referring to FIG. 2A, a flowchart of a system information programming method according to an embodiment of the disclosure is shown. Preferably, the system information programming method of the disclosure is performed by the memory controller 104. Also, the system information programming method of the disclosure can be performed by a host, which outputs an instruction to the data storage apparatus 100. The following descriptions are exemplified by the memory controller 104, but the disclosure is not limited thereto.

In step S202, a block is selected from the blocks on each plane of the LUN by the memory controller 104 to form a big block. The selected block is also referred as a member block which represents the block included in the big block. Refer to FIG. 2B. The memory controller 104 selects the blocks B11˜B41 on the planes PL1˜PL4 of the LUN of the non-volatile memory 102 to form a big block BB1, and the rest can be obtained by the same way. That is, the blocks B11˜B41 are member blocks of the big block BB1. Preferably, the memory controller 104 selects the blocks having the same block number from the planes PL1˜PL4 to form a big block. If the selected block is a bad block, the memory controller 104 can select another block (not bad block) from the same plane (that is, the plane on which the bad block is located) to replace the bad block. Preferably, the memory controller 104 records the block number (and the plane number) of each block of the big block.

In step S204, the big block is divided into a number of small blocks by the memory controller 104 according to a plane amount parameter. Let the plane amount parameter be exemplified by 2. The memory controller 104 divides the big block BB1 into 2 small blocks according to the plane amount parameter. The blocks B11˜B21 on the planes PL1˜PL2 are set as the first small block, and the blocks B31˜B41 on the planes PL3˜PL4 are set as the second small block. Also, for the blocks of the big block BB1, the memory controller 104 can set the blocks B11 and B31 on the planes PL1 and PL3 as the first small block, and set the blocks B21 and B41 on the planes PL2 and PL4 as the second small block, but the disclosure is not limited thereto.

In step S206, the pages on different planes of each small block are grouped by the memory controller 104 to form a number of big pages according to a page or plane orientation (for example, sequentially, but not limited thereto). FIG. 2B is a schematic diagram of big pages formed by sequentially grouping the pages on different planes of each small block by the memory controller 104 according to the plane orientation. In the above example, the memory controller 104 groups the page P1 on the plane PL1 and the page P1 on the plane PL2 of the first small block to form a big page BP1 (belonging to the big block BB1), then groups the page P1 on the plane PL3 and the page P1 on the plane PL4 of the second small block to form a big page BP2, then groups the page P2 on the plane PL1 and the page P2 on the plane PL2 of the first small block to form a big page BP3, and the rest can be obtained by the same way. At last, 2048 big pages can be formed. The big pages numbers respectively are BP1˜BP2048 as indicated in FIG. 2C. Preferably, the memory controller 104 groups the pages, which are on the planes PL1˜PL2 of each small block and have the same page number to form a big page. When one of the pages cannot be used, the memory controller 104 groups the pages, which are on the planes PL1˜PL2 or PL3˜PL4 of each small block but have different page numbers, to form a big page or skip this big page (the total amount of big pages will be 1 less than the expected amount).

FIG. 2D is a schematic diagram of big pages formed by sequentially grouping the pages on different planes of each small block by the memory controller 104 according to the page orientation. In the above example, the memory controller 104 groups the page P1 on the plane PL1 and the page P1 on the plane PL2 of the first small block to form a big page BP1, then groups the page P2 on the plane PL1 and the page P2 on the plane PL2 of the first small block to form a big page BP2, and the rest can be obtained by the same way. After the pages of the first small block are all grouped to form the big pages, the memory controller 104 then groups the page P1 on the planes PL3 and the page P1 on the plane PL4 of the second small block to form a big page BP1025, groups the page P2 on the plane PL3 and the page P2 on the plane PL4 of the second small block to form a big page BP1026, and the rest can be obtained by the same way. At last, 2048 big pages can also be formed.

FIG. 2D is a logic diagram of big pages BP1˜BP2048. The physical address of each big page BP is as indicated in FIG. 2B or FIG. 2C. Like the page, each big page can also be divided into a data area and a spare area. Generally speaking, the data area is used to store data, and the spare area is used to store the metadata of data. The data area of a big page preferably includes the data area of pages on different planes, and the spare area of a big page preferably includes the spare area of pages on different planes, but the disclosure is not limited thereto.

In step S208, the system information, the system information code, and the recording table are written to at least one of the big pages by the memory controller 104. The system information and the recording table preferably are written to the data areas of the big pages, and the system information code preferably is written to the spare areas of the big pages. Or, the system information is written to the data areas of the big page, and the system information code and the recording table are written to the spare areas of the big pages. The system information code is a designation or code assigned according to the type of system information. Table 1 is an example of the correspondence table between the system information code and the type of the system information. As indicated in Table 1, each type of system information has a system information code, different types of system information correspond to different system information codes, and the same type of system information corresponds to the same system information code. Moreover, different types of system information may have different maximum or different default data amount. Let the system information of basic specification type be taken for example. The system information code is A, the default data amount is 5 KB, and other types can be obtained by the same way.

TABLE 1

| System | | Default Size |
|---|---|---|
| Information Code | Type of System Information | (Maximum) |
| A | Basic specifications | 5 KB |
| B | Operating parameters | 5 KB |
| C | Mapping information table | 90 KB |
| D | Block linking table | 30 KB |
| E | Bad block information | 10 KB |

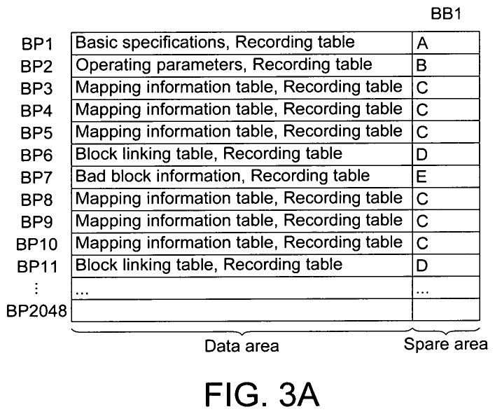

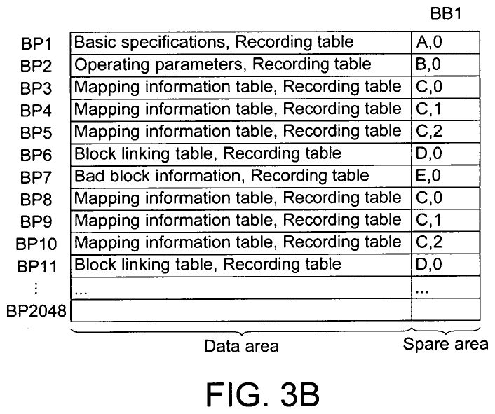

Referring to FIG. 3A, an embodiment of step S208 is shown. The big block BB1 includes 2048 big pages BP1˜BP2048. Each big page BP includes a 32 KB data area and a 256B spare area. To simplify the explanation, the “system information code” is referred as the “code” here below. Firstly, the memory controller 104 writes the basic specifications, the code “A” and the recording table to the big page BP1. Then, the memory controller 104 writes the operating parameters, the code “B”, and the recording table to the big pages BP2. Then, the memory controller 104 writes the mapping information table (for example, the mapping information table #A), the code “C”, and the recording table to the big pages BP3˜BP5. Then, the memory controller 104 writes the block linking table (for example, the block linking table #A), the code “D”, and the recording table to the big pages BP6. Then, the memory controller 104 writes the bad block information, the code “E”, and the recording table to the big pages BP7. If the content of the mapping information table #A and that of the block linking table #A change or are updated due to the operation of the data storage apparatus 100, then the memory controller 104 writes the updated mapping information table (the mapping information table #B), the code “C”, and the recording table to the big pages BP8˜BP10, and writes the updated block linking table (the block linking table #B), the code D, and the recording table to the big pages BP11, and the rest can be obtained by the same way. That is, whenever the system information is changed or updated, the updated system information will be written to the big page after the last big page used in the previous writing operation.

Table 2 is an embodiment of the recording table. The recording table is used to record the storage address of the most updated version of all types of system information, for example, the page number of the big page of the big block BB1. After the system information is updated, the updated recording table is also stored to the big pages. When the data storage apparatus 100 is activated again, the memory controller 104 can read the last valid big page of the big block BB1 (that is, the big page storing valid data, for example, the big page BP11) to obtain the storage address of the most updated version of each type of system information to accelerate the re-activation procedure of the data storage apparatus 100.

TABLE 2

| Type of System Information | Page Number |
|---|---|
| Basic specifications | BP1 |
| Operating parameters | BP2 |
| Mapping information table | BP8 |
| Block linking table | BP11 |
| Bad block information | BP7 |

In an embodiment, when the storage of any type of system information (for example, the mapping information table) requires more than two big pages, the recording table can only be stored to the last page of the big pages used to store this type of system information. Let the mapping information table of previous embodiment be taken for example. The storage of the mapping information table only requires three big pages, and the recording table can be stored to the third page of the three big pages. For example, the big pages BP3˜BP5 can be used to store the mapping information table, and the recording table can be stored to the big page BP5 only.

Referring to FIG. 3B, another embodiment of step S208 is shown. In the present embodiment, apart from the information stored in the previous embodiment, a page number is also stored. The page number indicates which part of the complete system information is stored to the current big page. For example, the mapping information table #B is predetermined to be stored to three big pages. When the memory controller 104 writes the mapping information table #B, the code “C”, and the recording table to the big pages BP8˜BP10, the page numbers 0, 1, and 2 are also stored to the spare areas of the big pages BP8˜BP10. The page number can be used as a basis for determining whether the system information is correctly and completely stored or not. For example, when the data storage apparatus 100 is activated again, it is determined that the last valid big page BP is the big page BP9, but the recording table shows that the mapping information table #B is stored to the big page BPB. Therefore, some data of the mapping information table #B are stored to the big pages BP9˜BP10. Since the last valid big page is the big page BP9 whose page number is 1, the memory controller 104 determines that the mapping information table #B is not completely stored. Since the mapping information table is not completely stored, preferably, the memory controller 104 can activate or enable an error processing mechanism. For example, a mapping information table re-build procedure can be activated to rebuild the mapping information table #B. Since the error processing mechanism is known to the person skilled in the art, the details are not repeated here.

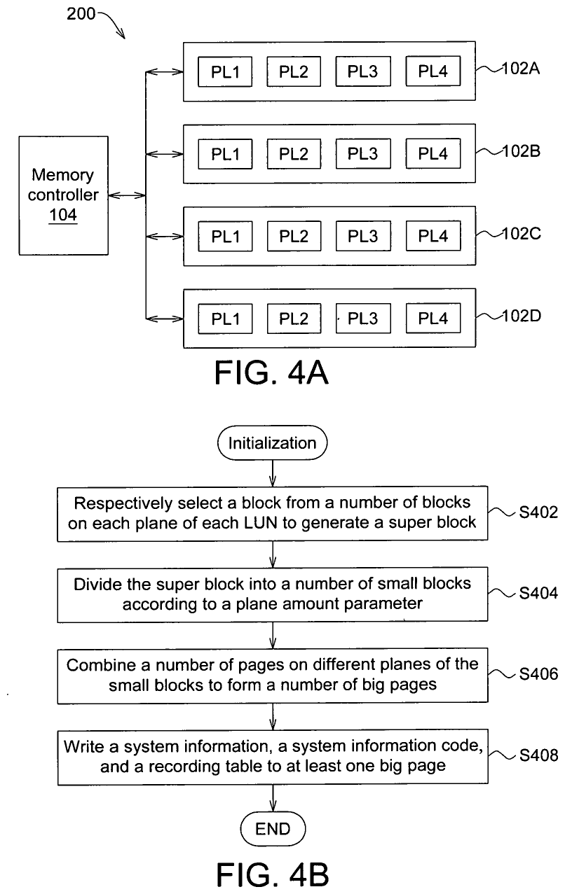

Referring to FIG. 4A, a block diagram of a data storage apparatus according to another embodiment of the disclosure is shown. The non-volatile memory of the data storage apparatus 200 may include 4 LUNs 102A˜102D and the memory controller 104. Each of the LUNs 102A˜102D has a structure identical to or similar with the structure of the non-volatile memory 102, and each of the LUNs 102A˜102D has an independent channel connected to the memory controller 104. The memory controller 104 can simultaneously enable the LUNs 102A˜102D with the same or different chip enabling signals to access data. In theory, the memory controller 104 can simultaneously access the LUNs 102A˜102D. Therefore, the data throughput of the data storage apparatus 200 is 4 times of the data storage apparatus 100.

Referring to FIG. 4B, a flowchart of a system information programming method according to another embodiment of the disclosure is shown. In step S402, a block is respectively selected from the blocks on each plane of each LUN by the memory controller 104 to form a super block. The selected block is also referred as a member block which represents the block included in the super block (or the big block). Like step S202, the blocks B11˜B41 on the planes PL1˜PL4 of each of the LUNs 102A˜102D are selected by the memory controller 104 to form a big block, which is also referred as a super block SB1, and the rest can be obtained by the same way. Preferably, the memory controller 104 selects the blocks, which are on the planes PL1˜PL4 of the LUNs 102A˜102D and have the same block number, to form a super block. If the selected block is a bad block, the memory controller 104 can select another block (not bad block) from the same plane (that is, the plane on which the bad block is located) to replace the bad block. Preferably, the memory controller 104 records the block number, the plane number, and the LUN of each block of the super block or a combination thereof.

In step S404, the super block is divided into a number of small blocks by the memory controller 104 according to a plane amount parameter. Let the plane amount parameter be exemplified by 2. For the blocks of the super block SB1, the memory controller 104 can set the blocks B11˜B21 on the planes PL1˜PL2 of the LUN 102A as the first small block, set the blocks B31˜B41 on the planes PL3˜PL4 of the LUN 102A as the second small block, set the blocks B31˜B41 on the planes PL3˜PL4 of the LUN 102D as the 8-th small block. Also, for the blocks of the super block SB1, the memory controller 104 can set the blocks B11 and B31 on the planes PL1 and PL3 of the LUN 102A as the first small block and set the blocks B21 and B41 on the planes PL2 and PL4 as the second small block, but the disclosure is not limited thereto.

In step S406, all pages on different planes of each small block are grouped by the memory controller 104 according to a page or plane orientation (for example, sequentially) to form a number of big pages. When it is according to the plane orientation, the memory controller 104 groups the page P1 on the plane PL1 and the page P1 on the plane PL2 of the first small block to form a big page BP1, groups the page P1 on the plane PL3 and the page P1 on the plane PL4 of the second small block to form a big page BP2. For the third small block, the memory controller 104 groups the page P1 on the plane PL1 and the page P1 on the plane PL2 to form a big page BP3, and the rest can be obtained by the same way. At last, 8192 big pages are formed, and the big page numbers respectively are BP1˜BP8192. In another embodiment, when it is according to the page orientation, the memory controller 104 groups the page P1 on the plane PL1 and the page P1 on the plane PL2 of the first small block to form a big page BP1, groups the page P2 on the plane PL1 and the page P2 on the plane PL2 of the first small block to form a big page BP2, and the rest can be obtained by the same way. After all pages of the first small block are grouped to form the big pages, the memory controller 104 then groups the page P1 on the plane PL3 and the page P1 on the plane PL4 of the second small block to form a big page BP1025, groups the page P2 on the planes PL3 and the page P2 on the plane PL4 of the second small block to form a big page BP1026. Other pages on the planes can be grouped to form corresponding big pages by the same way. Similarly, 8192 big pages can also be formed.

In step S408, the system information, the system information code, and the recording table are written to at least one of the big pages by the memory controller 104. Like step S208, after the big pages are formed, the memory controller 104 can use the big pages to store the system information. The formats, details and variations by which the memory controller 104 writes the system information to the big pages of the super block are similar to the formats, details and variations of relevant embodiments of the apparatus information disclosed above, and are not repeated here.

The data storage apparatus and the system information programming method of the disclosure effectively use the data storage space of the data storage apparatus. Furthermore, when recording the system information, the data storage apparatus and the system information programming method also record the system information code and the recording table to accelerate the data restoring procedure.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data storage apparatus, comprising:
a non-volatile memory, comprising a logical unit number (LUN), wherein the LUN comprises a plurality of planes, each of the planes comprises a plurality of blocks, and each of the blocks comprises a plurality of pages; and
a memory controller coupled to the non-volatile memory and configured to select a plurality of member blocks from the blocks on each of the planes of the LUN to form a big block, divide the big block into a plurality of small blocks according to a plane amount parameter, group the pages of each of the small blocks on different planes to form a plurality of big pages according to a page or plane orientation, and write a system information to at least one of the big pages.

2. The data storage apparatus according to claim 1, wherein each of the big pages comprises a data area and a spare area, and the system information is written to the data area of at least one of the big pages.

3. The data storage apparatus according to claim 1, wherein when writing the system information to the at least one of the big pages, the memory controller further writes a system information code to the at least one of the big pages.

4. The data storage apparatus according to claim 1, wherein when writing the system information to the at least one of the big page, the memory controller further writes a recording table to the at least one of the big pages.

5. The data storage apparatus according to claim 4, wherein the recording table records a plurality of storage addresses of a plurality of types of system information.

6. The data storage apparatus according to claim 2, wherein when writing the system information to the at least one of the big page, the memory controller further writes a page number to the spare area of the at least one of the big pages.

7. A data storage apparatus, comprising:
a non-volatile memory, comprising a plurality of logical unit numbers (LUNs), each of the LUNs comprises a plurality of planes, each of the planes comprises a plurality of blocks, and each of the blocks comprises a plurality of pages; and
a memory controller coupled to the memory and configured to select a plurality of member blocks from the blocks on each plane of the LUNs to form a super block, divide the super block into a plurality of small blocks according to a plane amount parameter, group the pages of each small block on different planes to form a plurality of big pages according to a page or plane orientation, and write a system information to at least one of the big pages.

8. The data storage apparatus according to claim 7, wherein each big page comprises a data area and a spare area, and the memory controller writes the system information to the data area of the at least one of the big pages.

9. The data storage apparatus according to claim 7, wherein when writing the system information to the at least one of the big pages, the memory controller further writes a system information code to the at least one of the big pages.

10. The data storage apparatus according to claim 7, wherein when writing the system information to the at least one big page, the memory controller further writes a recording table to the at least one of the big pages.

11. The data storage apparatus according to claim 10, wherein the recording table records a plurality of storage addresses of a plurality of types of system information.

12. The data storage apparatus according to claim 7, wherein when writing the system information to the at least one of the big pages, the memory controller further writes a page number to the spare area of the at least one of the big pages.

13. A system information programming method for a data storage apparatus, comprising:
respectively selecting a member block from a plurality of blocks on each plane of a logical unit number (LUN) of a non-volatile memory to form a big block;
dividing the big block into a plurality of small blocks according to a plane amount parameter;
grouping a plurality of pages of each small block on different planes to form a plurality of big pages according to a page or plane orientation; and
writing a system information to at least one of the big pages.

14. The programming method according to claim 13, wherein each of the big pages comprises a data area and a spare area, and the system information is written to the data area of the at least one of the big pages.

15. The programming method according to claim 14, further comprising writing a page number to the spare area of the at least one of the big pages.

16. The programming method according to claim 13, wherein the step of writing the system information to the at least one of the big pages further comprising writing a system information code to the at least one of the big page.

17. The programming method according to claim 13, wherein the step of writing the system information to the at least one of the big pages further comprising writing a recording table to the at least one of the big pages.

18. The programming method according to claim 17, wherein the recording table is configured to record a plurality of storage addresses of a plurality of types of system information.

19. A system information programming method for a data storage apparatus, comprising:
respectively selecting a member block from a plurality of blocks on each plane of a plurality of LUNs of the non-volatile memory to form a super block;
dividing the super block into a plurality of small blocks according to a plane amount parameter;
grouping a plurality of pages of each small block on different planes to form a plurality of big pages according to a page or plane orientation; and
writing a system information to at least one of the big pages.

20. The programming method according to claim 19, wherein each of the big pages comprises a data area and a spare area, and the system information is written to the data area of the at least one of the big pages.

21. The programming method according to claim 20, further comprising writing a page number to the spare area of the at least one of the big pages.

22. The programming method according to claim 19, wherein the step of writing the system information to the at least one of the big pages further comprising writing a system information code to the at least one of the big pages.

23. The programming method according to claim 19, wherein the step of writing the system information to the at least one of the big pages further comprising writing a recording table to the at least one of the big pages.

24. The programming method according to claim 23, wherein the recording table is configured to record a plurality of storage address of a plurality of types of system information.
